(19) United States
(12) Patent Application Publication
(10) Pub. No.: US 2025/0026288 A1
(43) Pub. Date: Jan. 23, 2025

(54) DRIVING ASSISTANCE DEVICE, DRIVING ASSISTANCE METHOD, AND NON-TRANSITORY RECORDING MEDIUM

(71) Applicant: TOYOTA JIDOSHA KABUSHIKI KAISHA, Toyota-shi Aichi-ken (JP)

(72) Inventor: Anil SHENOY, Shinjuku-ku Tokyo-to (JP)

(73) Assignee: TOYOTA JIDOSHA KABUSHIKI KAISHA, Toyota-shi Aichi-ken (JP)

(21) Appl. No.: 18/775,434

(22) Filed: Jul. 17, 2024

(30) Foreign Application Priority Data
Jul. 20, 2023 (JP) 2023-118461

(51) Int. Cl. B60R 16/037; B60W 30/02; B60W 30/18

(52) U.S. Cl. CPC B60R 16/0373; B60W 30/025; B60W 30/18163

(57) ABSTRACT

A driving assistance device includes an acquisition unit which acquires a voice question about ADAS accepted from a driver driving a vehicle, a voice recognition unit which recognizes the voice question about the ADAS acquired by the acquisition unit, and a response generation unit which uses LLM and generates a voice response corresponding to the voice question about the ADAS recognized by the voice recognition unit.

### CROSS-REFERENCE TO RELATED APPLICATIONS

This application claims priority to Japanese Patent Application No. 2023-118461 filed Jul. 20, 2023, the entire contents of which are herein incorporated by reference.

### FIELD

The present disclosure relates to driving assistance device, driving assistance method, and non-transitory recording medium.

### BACKGROUND

PTL 1 (Japanese Unexamined Patent Publication No. 2021-117941) describes an agent device which accepts vehicle state information from a vehicle, accepts a question from a user, estimate intent of the question, and acquires a response to the question based on the estimated intent of the question. PTL 1 describes that the question is texted by voice recognition. Further, PTL 1 describes that information relating to the response to the question is received from an agent server.

In PTL 1, as the questions from the user, a question asking how to turn off a lamp, a question asking what kind of switch it is, and a question asking what a light (tire pressure waring light) in a meter is are exemplified. However, in PTL 1, a question about ADAS (Advanced Driver-Assistance Systems) is not exemplified.

The ADAS includes a function such as ACC (Adaptive Cruise Control), lane change assist or the like. The driver cannot perform an operation to activate the function when the vehicle is stopping but can perform the operation to activate the function only when the vehicle is traveling. It is assumed that the question relating to the function of the ADAS is asked by the driver who is driving the vehicle. To enable, for example, a driver unfamiliar with the ADAS to activate the function of the ADAS when the vehicle is traveling, it is necessary to quickly generate a voice response corresponding to the question relating to the function of the ADAS.

However, in the technique described in PTL 1, it is not considered that it is necessary to quickly generate the voice response corresponding to the question. Therefore, in the technique described in PTL 1, there is a possibility that it is impossible to appropriately generate the voice answer corresponding to the driver's voice question about the ADAS.

### SUMMARY

In view of the above-mentioned score, the present disclosure has as its object the provision of driving assistance device, driving assistance method, and non-transitory recording medium which can appropriately generate a voice response corresponding to a driver's voice question about ADAS.
(1) One aspect of the present disclosure is a driving assistance device including a processor configured to: acquire a voice question about ADAS accepted from a driver driving a vehicle; recognize the voice question about the ADAS; and generate a voice response corresponding to the voice question about the ADAS using LLM (Large Language Models).
(2) In the driving assistance device of the aspect (1), the processor may be configured to: acquire the voice question accepted from the driver when speed of the vehicle is greater than zero and asking whether it is a situation in which a function of the ADAS, which cannot be activated when the speed of the vehicle is less than a threshold, can be activated, information showing a state of the vehicle when the voice question asking whether it is the situation in which the function of the ADAS can be activated is accepted from the driver, location information of the vehicle when the voice question asking whether it is the situation in which the function of the ADAS can be activated is accepted from the driver, and information describing a condition under which the function of the ADAS can be activated; recognize the voice question asking whether it is the situation in which the function of the ADAS can be activated; and generate the voice response corresponding to the voice question asking whether it is the situation in which the function of the ADAS can be activated based on the voice question asking whether it is the situation in which the function of the ADAS can be activated, the information showing a state of the vehicle, the location information of the vehicle, and the information describing the condition under which the function of the ADAS can be activated when the speed of the vehicle is greater than zero, the processor may be configured to generate the voice response explaining an operation of the driver required to activate the function of the ADAS when it is the situation in which the function of the ADAS can be activated and the speed of the vehicle is greater than zero.
(3) In the driving assistance device of the aspect (1) or (2), the function of the ADAS may include a lane change assist, the processor may be configured to generate the voice response explaining a range of the speed of the vehicle where the lane change assist can be activated when the processor acquires the voice question about the range of the speed of the vehicle where the lane change assist can be activated accepted from the driver driving the vehicle.
(4) Another aspect of the present disclosure is a driving assistance method including: acquiring a voice question about ADAS accepted from a driver driving a vehicle; recognizing the voice question about the ADAS; and generating a voice response corresponding to the voice question about the ADAS using LLM.
(5) Another aspect of the present disclosure is a non-transitory recording medium having recorded thereon a computer program for causing a processor to execute a process including: acquiring a voice question about ADAS accepted from a driver driving a vehicle; recognizing the voice question about the ADAS; and generating a voice response corresponding to the voice question about the ADAS using LLM.

According to the present disclosure, it is possible to appropriately generate a voice response corresponding to a driver's voice question about ADAS.

### BRIEF DESCRIPTION OF DRAWINGS

FIG. 1 is a view showing an example of a vehicle to which a driving assistance device of a first embodiment is applied.

FIG. 2 is a view showing an example of a specific configuration of the driving assistance device shown in FIG. 1.

FIG. 3 is a view for explaining a first example of processing performed in the vehicle to which the driving assistance device of the first embodiment is applied.

FIG. 4 is a flowchart for explaining an example of processing performed by the driving assistance device of the first embodiment.

FIG. 5 is a view showing an example of the vehicle to which the driving assistance device of a second embodiment is applied.

FIG. 6 is a view showing an example of a flow of data and the like in the vehicle and the like to which the driving assistance device of the second embodiment is applied.

### DESCRIPTION OF EMBODIMENTS

Below, referring to the drawings, embodiments of driving assistance device, driving assistance method, and non-transitory recording medium of the present disclosure will be explained.

### First Embodiment

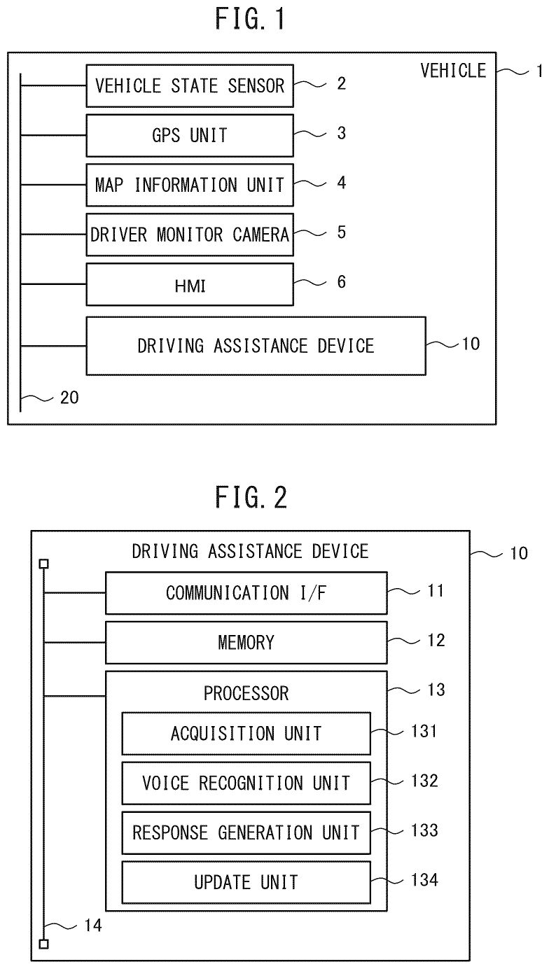

FIG. 1 is a view showing an example of a vehicle 1 to which a driving assistance device 10 of a first embodiment is applied. FIG. 2 is a view showing an example of a specific configuration of the driving assistance device 10 shown in FIG. 1.

In the example shown in FIG. 1 and FIG. 2, the vehicle 1 includes vehicle state sensor 2, GPS (Global Positioning System) unit 3, map information unit 4, driver monitor camera 5, HMI (Human Machine Interface) 6, and the driving assistance device 10. The vehicle state sensor 2, the GPS unit 3, the map information unit 4, the driver monitor camera 5, the HMI 6, and the driving assistance device 10 are connected via an in-vehicle network 20.

In the example shown in FIG. 1 and FIG. 2, the vehicle 1 includes the vehicle state sensor 2, the GPS unit 3, the map information unit 4, the driver monitor camera 5, and the HMI 6. However, in another example, the vehicle 1 may not include all of them. In still other example, the vehicle 1 may include other sensor or the like (e.g., external sensor or the like) in addition to all or a part thereof.

In the example shown in FIG. 1 and FIG. 2, the vehicle state sensor 2 includes, for example, vehicle speed sensor, brake pedal sensor, accelerator pedal sensor, lane division line detecting device, seat belt sensor, door sensor, ABS (anti-lock brake system) determination device which determines whether an ABS is in a state in which the ABS can be activated, or the like.

In another example, the vehicle state sensor 2 may not include all of the sensors described above. In still other example, the vehicle state sensor 2 may include other sensor or the like (for example, the external sensor or the like) in addition to all or a part of the sensors or the like described above.

In the example shown in FIG. 1 and FIG. 2, the driving assistance device 10 includes communication interface (I/F) 11, memory 12, processor 13, and signaling line 14. The driving assistance device 10 may be configured by a computer such as Rasbury Pie (registered trademark) or the like. The driving assistance device 10 may be configured by a driving assistance ECU (electronic control unit).

In the example shown in FIG. 1 and FIG. 2, the processor 13 has function as an acquisition unit 131, function as a voice recognition unit 132, function as a response generation unit 133, and function as an update unit 134.

The acquisition unit 131 acquires a voice question about ADAS accepted by the HMI 6 from a driver who is driving the vehicle 1. The acquisition unit 131 acquires a signal (vehicle state signal which is an output signal of the vehicle state sensor 2) indicating a vehicle state detected by the vehicle state sensor 2. Furthermore, the acquisition unit 131 acquires location information indicating a location of the vehicle 1 identified based on a GPS signal received by the GPS unit 3 and map information stored in the map information unit 4. The acquisition unit 131 acquires data of a user manual (operating instructions) in PDF format, for example, stored in the memory 12.

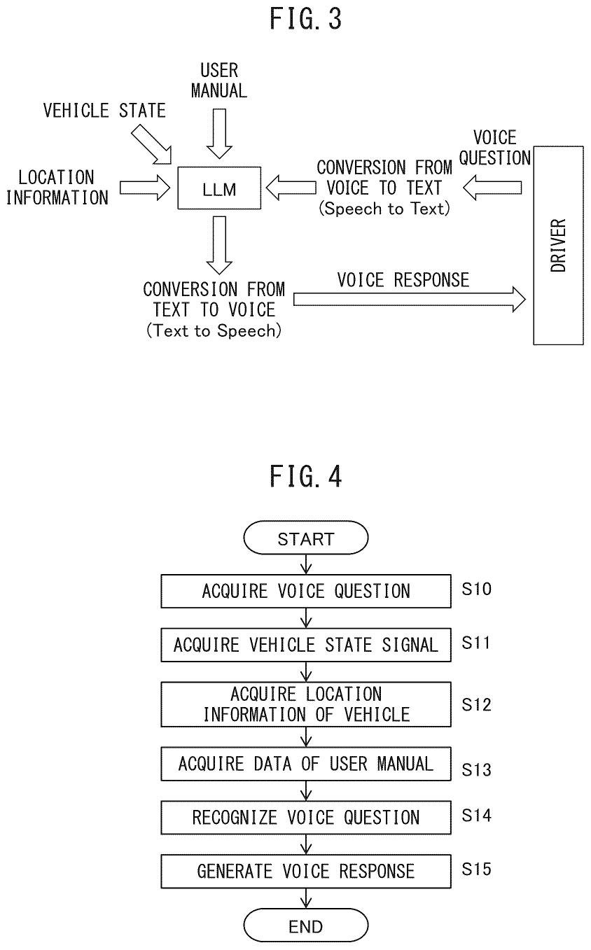

The voice recognition unit 132 recognizes the voice question about the ADAS acquired by the acquisition unit 131. The voice recognition unit 132 recognizes the voice question about the ADAS acquired by the acquisition unit 131 by using a technique similar to a technique described in, for example, paragraph 0031 and paragraphs 0033 to 0036 of Japanese Patent No. 7062958 (explanation part of FIG. 2A and FIG. 3 (speech recognition device 10A, speech recognition section 30A, and information generation section 31A) of the corresponding U.S. patent Ser. No. 11/011,167.

The response generation unit 133 may use LLM (Large Language Models). The LLM is a language model constructed using a very huge dataset and deep learning techniques. The LLM has more computational complexity, more data, and more parameters than conventional natural language models. The LLM enables fluent conversations close to human beings, and various processes using natural languages can be performed with high accuracy. Typical examples of the LLM include the “BERT” announced by Google in 2018 and the “GPT-3” announced by OpenAI in 2020. As one of the applications of the LLM, “ChatGPT” announced in December 2022 is known. The “ChatGPT” is a fine-tuning of “GPT-3.5 series” trained in the beginning of 2022, for chatting (dialogue). The response generation unit 133 may use a known (e.g., open-sourced) LLM as the LLM.

The response generation unit 133 generates a voice response corresponding to the voice question about the ADAS recognized by the voice recognition unit 132 by using the LLM installed in the driving assistance device 10.

The update unit 134, for example, in response to the update of the function of ADAS or the like, updates the voice response corresponding to the voice question about the ADAS generated by the response generation unit 133.

FIG. 3 is a view for explaining a first example of processing performed in the vehicle 1 to which the driving assistance device 10 of the first embodiment is applied.

In the example shown in FIG. 3, the HMI 6 accepts the voice question of “Can I activate ACC now?” from the driver of the vehicle 1, and the acquisition unit 131 acquires the voice question. The voice recognition unit 132 recognizes the voice question acquired by the acquisition unit 131. In particular, the voice recognition unit 132 performs textualization of the voice question. The response generation unit 133 acquires a question textualized by the voice recognition unit 132.

When the HMI 6 accepts the voice question, the vehicle speed sensor detects the speed of the vehicle 1 (55 mph (approx. 88.5 km/h)), the brake pedal sensor detects the off state of the brake pedal, the accelerator pedal sensor detects the on state of the accelerator pedal, the seat belt sensor detects the wearing state of the seat belt of the driver's seat, the door sensor detects the closed state of the door of the vehicle 1, and the ABS determination device determines that the ABS is in the state in which the ABS can be activated (the ABS is not in a state in which the ABS cannot be activated). The acquisition unit 131 acquires the detection result and the determination result as the vehicle state signal, and the response generation unit 133 acquires the vehicle state signal.

Further, when the HMI 6 accepts the voice question, the GPS unit 3 and the map information unit 4 identify that the vehicle 1 is traveling on a highway provided with a lane mark (lane compartment line). The acquisition unit 131 acquires the identified result as the location information of the vehicle 1, and the response generation unit 133 acquires the location information.

Further, when the HMI 6 accepts the voice question, the acquisition unit 131 acquires the data of the user manual stored in the memory 12. The user manual describes the speed of the vehicle 1 being 20 mph (approx. 32.2 km/h) or more (not less than the threshold value), the brake pedal being in the off state, the accelerator pedal is in the on state, the seat belt of the driver's seat being in the wearing state, the door of the vehicle 1 being in the closed state, that ABS being in the state in which the ABS can be activated, and that the vehicle 1 being traveling on the highway or the like on which the lane mark is provided, as conditions for activating the ACC of the vehicle 1. The response generation unit 133 acquires the data of the user manual.

In another example, the conditions for activating the ACC of the vehicle 1 may be different from the conditions described above.

In the example shown in FIG. 3, the response generation unit 133 uses the LLM to generate the voice response corresponding to the voice question of “Can I activate ACC now?” from the driver of the vehicle 1 based on the question of “Can I activate ACC now?” from the driver of the vehicle 1, the vehicle state signal, the location information of the vehicle 1 and the user manual.

Specifically, the response generation unit 133 determines that the state of the vehicle 1 indicated by the vehicle state signal and the location of the vehicle 1 satisfy the condition for activating the ACC of the vehicle 1 described in the user manual and generates the voice response indicating that it is a situation in which the ACC can be activated.

The response generation unit 133 also generates the voice response explaining the operation of the driver of the vehicle 1 required to activate the ACC.

Specifically, the response generation unit 133 generates the text information “The ACC can be activated now because the vehicle speed is higher than 20 mph (about 32.2 km/h) and the vehicle 1 is traveling on the highway where the lane mark (lane compartment line) is provided. Please click ACC button in order to activate the ACC.” and generates the voice response by performing conversion from the text information to voice information. The HMI 6 outputs the voice response generated by the response generation unit 133.

In the example shown in FIG. 3, the response generation unit 133 generates the voice response explaining the operation of the driver of the vehicle 1 required to activate the ACC, but in another example, the response generation unit 133 may not generate the voice response explaining the operation of the driver of the vehicle 1 required to activate the ACC.

As described above, in the example shown in FIG. 3, the voice response corresponding to the voice question asked by the driver of the vehicle 1 while the vehicle 1 is traveling at 55 mph (about 88.5 km/h) is generated by the response generation unit 133 without the need to reduce the vehicle speed of the vehicle 1 to zero (without the need to reduce the vehicle speed of the vehicle 1 to less than the threshold value). Therefore, the driver of the vehicle I can activate the ACC immediately (i.e., without the need to increase the vehicle speed of the vehicle to the threshold or more after the vehicle speed of the vehicle 1 is reduced to zero once) according to the voice response generated by the response generator 133.

That is, in the example shown in FIG. 3, it is possible to appropriately (quickly and accurately) generate the voice response to the voice question of the driver about the ACC.

The designation of the ACC differs among automakers. For example, in Toyota, the ACC is referred to as radar cruise control, and in Mercedes, the ACC is referred to as distronic plus.

Therefore, in a second example of processing performed in the vehicle 1 to which the driving assistance device 10 of the first embodiment is applied, countermeasures are taken against the designation of the ACC differing among the automakers. Specifically, in the second example, for example, at the time of manufacturing of the vehicle 1 or the like, information indicating the designation of the ACC in each automaker is stored in advance in the memory 12.

When the HMI 6 accepts the voice question of “What is the vehicle speed at which the ACC can be activated?” from the driver of the vehicle 1, the response generation unit 133 generates the voice response of the speed (20 mph (about 32.2 km/h) or more) of the vehicle 1 at which the ACC can be activated, and generates the voice response explaining the designation of the ACC in the automaker which manufactured the vehicle 1. The response generation unit 133 generates the voice response explaining the operation of the driver of the vehicle I required to activate the ACC and the operation of the HMI 6 associated therewith (for example, a display screen of the HMI 6 or the like). Furthermore, the response generation unit 133 generates the voice response explaining the requirement for activating the ACC of the vehicle 1, the inter-vehicle distance control performed during the operation of the ACC, and the like.

In a third example of the processing performed in the vehicle 1 to which the driving assistance device 10 of the first embodiment is applied, as in the second example described above, the countermeasures are taken against the designation of the ACC differing among the automakers. In the third example, the vehicles I may not include the GPS unit 3 and the map-information unit 4.

In the third example, when the HMI 6 accepts the voice question of “The vehicle 1 is traveling at 80 km/h on the ΔΔ highway. Is it possible to operate ACC, now?” from the driver of the vehicle 1, the response generation unit 133 generates the voice response indicating that the ACC can be activated while the vehicle 1 is traveling at 80 km on the ΔΔ highway and generates the voice response explaining the designation of the ACC in the automaker which manufactured the vehicle 1. The response generation unit 133 generates the voice response explaining the operation of the driver of the vehicle I required to activate the ACC and the operation of the HMI 6 associated therewith (for example, the display screen of the HMI 6 or the like). Furthermore, the response generation unit 133 generates the voice response explaining behavioral change (acceleration) of the vehicle 1 according to behavioral change (lane change, acceleration) of the behavior of a preceding vehicle at low speed during the operation of the ACC. The response generation unit 133 generates the voice response explaining the requirement for activating the ACC of the vehicle 1, the inter-vehicle distance control performed during the operation of the ACC, obligations of the driver during the operation of the ACC, and the like.

In a fourth example of the processing performed in the vehicle I to which the driving assistance device 10 of the first embodiment is applied, as in the third example described above, the vehicles I may not include the GPS unit 3 and the map-information unit 4.

In the fourth example, when the HMI 6 accepts the voice question of “I will move the vehicle 1 in the parking lot. Can the ACC be activated at 5 km/h?” from the driver of the vehicle 1, the response generation unit 133 generates the voice response explaining that the vehicle speed of the vehicle 1 at which the ACC can be activated is equal to or higher than 20 miles per hour (about 32.2 km/h), and generates the voice response explaining the designation of the ACC in the automaker which manufactured the vehicle 1. Additionally, the response generation unit 133 generates the voice response indicating that ACC cannot be activated when the vehicle speed of the vehicle 1 is at 5 km/h.

In a fifth example of the processing performed in the vehicle 1 to which the driving assistance device 10 of the first embodiment is applied, as in the second example described above, for example, at the time of manufacturing of the vehicle 1 or the like, the information indicating the designation of the ACC in each automaker is stored in advance in the memory 12.

When the HMI 6 accepts the voice question of “What is the operation required to operate ACC?” from the driver of the vehicle I and the designation of the ACC in another automaker differing from the automaker which manufactured the vehicle 1 is used in the voice question, the response generation unit 133 generates the voice response explaining that the designation of the ACC used by the driver is not the designation of the ACC in the automaker which manufactured the vehicle 1, but the designation of the ACC in the other automaker. Additionally, the response generation unit 133 generates the voice response which provides useful advice to the driver of the vehicle 1 who used to be the driver of a vehicle manufactured by the other automaker (advice for the driver to easily distinguish between the function of the ACC of the vehicle 1 and the function of the ACC of the vehicle manufactured by the other automaker).

In a sixth example of the processing performed in the vehicle 1 to which the driving assistance device 10 of the first embodiment is applied, when the HMI 6 accepts the voice question of “What is the operation required to turn off a road sign assist (which is a function for displaying a road sign recognized by a camera mounted on the vehicle 1 on a screen of the HMI 6)?” from the driver of the vehicle 1, the response generation unit 133 generates the voice response explaining the operation of the driver of the vehicle 1 required to turn off the road sign assist, the operation of the HMI 6 associated therewith (for example, the displaying screen of the HMI 6, etc.) and the like on the basis of the question from the driver of the vehicle 1 and an explanation of the operation required to turn off the load sign assist included in the user manual.

In a seventh example of the processing performed in the vehicle I to which the driving assistance device 10 of the first embodiment is applied, when the HMI 6 accepts the voice question of “Cannot the ACC be activated in a state in which ABS cannot be activated? What is the problem?” from the driver of the vehicle 1, the response generation unit 133 generates the voice response that the ACC cannot be activated in the state in which the ABS cannot be activated based on the question from the driver of the vehicle 1 and the condition for activating the ACC of the vehicle 1 included in the user manual (such as “the ABS being in an operable state”) and generates the voice response explaining the designation of the ACC in the automaker which manufactured the vehicle 1. The response generation unit 133 also generates the voice response explaining why the ACC cannot be activated in the state in which the ABS cannot be activated. Additionally, the response generation unit 133 generates the voice response explaining each of a plurality of conditions for activating the ACC of the vehicle 1.

In an eighth example of the processing performed in the vehicle 1 to which the driving assistance device 10 of the first embodiment is applied, not only the data of the user manual of the vehicle 1, but also the data of the user manual for a previous model of the vehicle 1 is stored in the memory 12. When the HMI 6 accepts the voice question of “Transfer from the previous model of the vehicle 1 to the vehicle 1 (current model) is performed. What is new that we need to know?” from the driver of the vehicle 1, the response generation unit 133 extracts a function (a new function) updated in the vehicle 1 (the current model) and generates the voice response explaining the extracted function on the basis of the question from the driver of the vehicle 1, the user manual of the vehicle 1 (the current model) and the user manual of the previous model of the vehicle 1.

In a ninth example of the processing performed in the vehicle 1 to which the driving assistance device 10 of the first embodiment is applied, the HMI 6 accepts the voice question of “What is the range of the vehicle speed in which the lane change assist (one of ADAS functions) can be activated?” from the driver driving the vehicle 1, and the acquisition unit 131 acquires the voice question. The voice recognition unit 132 recognizes the voice question acquired by the acquisition unit 131. In particular, the voice recognition unit 132 performs the textualization of the voice question. The response generation unit 133 acquires a question textualized by the voice recognition unit 132.

When the HMI 6 accepts the voice question, the acquisition unit 131 acquires the data of the user manual stored in the memory 12. The user manual describes that the vehicle speed of the vehicle 1 is approximately 85 to 130 km/h as the operation condition of the lane change assist of the vehicle 1 and the like. The response generation unit 133 acquires the data of the user manual.

In another example, the operation condition of the lane change assist of the vehicle 1 may be different from the condition described above.

In the ninth example, the response generation unit 133 uses the LLM and generates the voice response corresponding to the voice question of “What is the range of the vehicle speed in which the lane change assistance can be activated?” from the driver of the vehicle 1, based on the question of “What is the range of the vehicle speed in which the lane change assistance can be activated?” from the driver of the vehicle 1 and the user manual. Specifically, the response generation unit 133 generates the voice response explaining the range of the vehicle speed (about 85 to 130 km/h) in which the lane change assist can be activated.

FIG. 4 is a flowchart for explaining an example of processing performed by the driving assistance device of the first embodiment. Processing shown in FIG. 4 is performed, for example, while the vehicle 1 is traveling (specifically, when the speed of the vehicle 1 is higher than zero) and the like.

In the example shown in FIG. 4, at step S10, the acquisition unit 131 acquires the voice question of the driver of the vehicle 1 about the ADAS.

At step S11, the acquisition unit 131 acquires the vehicle state signal.

At step S12, the acquisition unit 131 acquires the location information of the vehicle 1.

At step S13, the acquisition unit 131 acquires the data of the user manual.

At step S14, the voice recognition unit 132 recognizes the voice question of the driver of the vehicle 1 about ADAS acquired at step S10 and performs the textualization of the voice question.

At step S15, the response generation unit 133 uses the LLM and generates the voice response corresponding to the voice question of the driver of the vehicle 1 about the ADAS acquired at step S10 based on the question of the driver of the vehicle 1 about the ADAS textualized at step S14, the vehicle state signal acquired at step S11, the location information of the vehicle 1 acquired at step S12, and the user manual indicated by the data acquired at step S13. Specifically, the response generation unit 133 generates the text response corresponding to the voice question of the driver of the vehicle 1 about the ADAS acquired at step S10, and then generates the voice response corresponding to the voice question of the driver of the vehicle 1 about the ADAS by performing the conversion from the text response to the voice response.

### Second Embodiment

Except for points to be described later, the vehicle 1 to which the driving assistance device of a second embodiment is applied is configured similarly to the vehicle 1 to which the driving assistance device 10 of the first embodiment described above is applied.

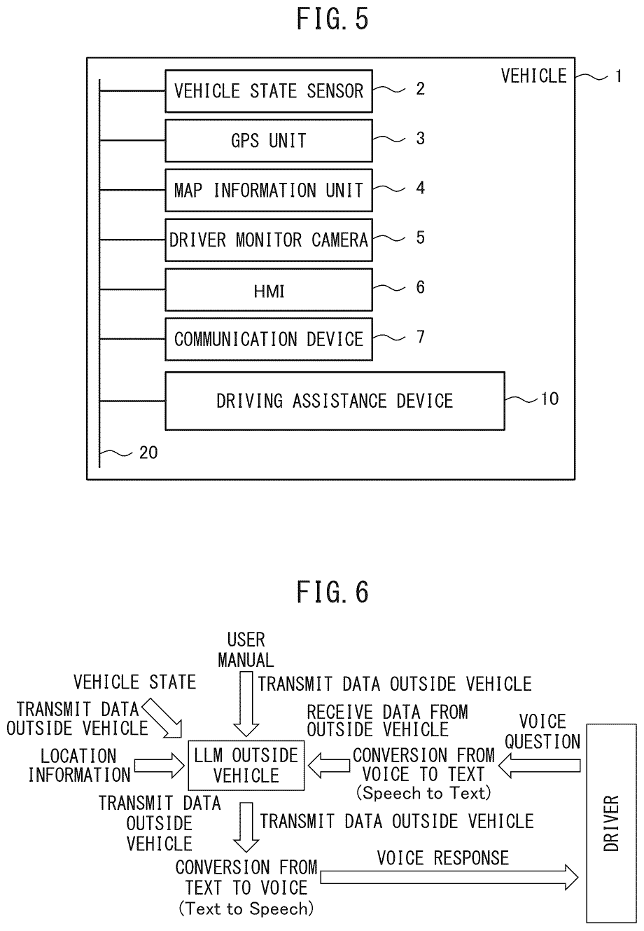

FIG. 5 is a view showing an example of the vehicle 1 to which the driving assistance device of the second embodiment is applied. FIG. 6 is a view showing an example of a flow of the data and the like in the vehicle 1 and the like to which the driving assistance device 10 of the second embodiment is applied.

In the example shown in FIG. 5 and FIG. 6, the vehicle 1 includes a communication device 7 which communicates with the outside of the vehicle 1. The response generation unit 133 generates the voice response corresponding to the voice question about the ADAS recognized by the voice recognition unit 132 by using the LLM on a server external to the vehicle 1, for example.

Specifically, the response generation unit 133 acquires the question textualized by the voice recognition unit 132 and causes the communication device 7 to perform processing for transmitting the question to the LLM external to the vehicle 1. The response generation unit 133 acquires the vehicle state signal generated by the vehicle state sensor 2 and causes the communication device 7 to perform processing for transmitting the vehicle state signal to the LLM external to the vehicle 1. Furthermore, the response generation unit 133 acquires the location information indicating the location of the vehicle 1 identified by the GPS unit 3 and the map information unit 4 and causes the communication device 7 to perform processing for transmitting the location information to the LLM external to the vehicle 1. The response generating unit 133 acquires the data of the user manual stored in the memory 12 and causes the communication device 7 to perform processing for transmitting the data to the LLM external to the vehicle 1.

Furthermore, the response generation unit 133 causes the communication device 7 to perform processing for receiving the processing result of the LLM external to the vehicle 1, and uses the processing result to generate the voice response corresponding to the voice question from the driver of the vehicle 1. Specifically, the response generation unit 133 generates the text information of the response corresponding to the question of the voice from the driver of the vehicle 1, and then generates the voice response by performing the conversion from the text information to the voice response.

In an example of a process performed in the vehicle 1 to which the driving assistance device of the second embodiment is applied, when the HMI 6 accepts the voice question of “What operation is required to perform update of OTA (Over-The-Air)?” from the driver of the vehicle 1, the response generation unit 133 generates the voice response explaining the operation of the driver of the vehicle 1 required to perform the update of the OTA and the like based on the question of the driver of the vehicle 1 and explanation of the operation required to perform the update of the OTA included in the user manual. The update of the OTA includes the update of the in-vehicle software or the like performed by the communication device 7 transmitting and receiving data by wireless communication with the outside of the vehicle 1.

As described above, although the embodiments of the driving assistance device, the driving assistance method, and the non-transitory recording medium of the present disclosure have been described with reference to the drawings, the driving assistance device, the driving assistance method, and the non-transitory recording medium of the present disclosure are not limited to the above-described embodiments, and appropriate changes can be made without departing from the scope of the present disclosure. The configuration of each example of the embodiment described above may be appropriately combined.

A program stored in the memory 12 of the driving assistance device 10 (the program which realizes the function of the processor 13 of the driving assistance device 10) may be recorded in a computer-readable storage medium such as, for example, a semiconductor memory, a magnetic recording medium, an optical recording medium (non-temporary storage medium) or the like for providing, distribution or the like.

1. A driving assistance device comprising a processor configured to:
acquire a voice question about ADAS (Advanced Driver-Assistance Systems) accepted from a driver driving a vehicle;
recognize the voice question about the ADAS; and
generate a voice response corresponding to the voice question about the ADAS using LLM (Large Language Models).

2. The driving assistance device according to claim 1, wherein
the processor is configured to:
acquire the voice question accepted from the driver when speed of the vehicle is greater than zero and asking whether it is a situation in which a function of the ADAS, which cannot be activated when the speed of the vehicle is less than a threshold, can be activated, information showing a state of the vehicle when the voice question asking whether it is the situation in which the function of the ADAS can be activated is accepted from the driver, location information of the vehicle when the voice question asking whether it is the situation in which the function of the ADAS can be activated is accepted from the driver, and information describing a condition under which the function of the ADAS can be activated;
recognize the voice question asking whether it is the situation in which the function of the ADAS can be activated; and
generate the voice response corresponding to the voice question asking whether it is the situation in which the function of the ADAS can be activated based on the voice question asking whether it is the situation in which the function of the ADAS can be activated, the information showing a state of the vehicle, the location information of the vehicle, and the information describing the condition under which the function of the ADAS can be activated when the speed of the vehicle is greater than zero,
the processor is configured to generate the voice response explaining an operation of the driver required to activate the function of the ADAS when it is the situation in which the function of the ADAS can be activated and the speed of the vehicle is greater than zero.

3. The driving assistance device according to claim 1, wherein
the function of the ADAS includes a lane change assist,
the processor is configured to generate the voice response explaining a range of a speed of the vehicle where the lane change assist can be activated when the processor acquires the voice question about the range of the speed of the vehicle where the lane change assist can be activated accepted from the driver driving the vehicle.

4. A driving assistance method comprising:
acquiring a voice question about ADAS accepted from a driver driving a vehicle;
recognizing the voice question about the ADAS; and
generating a voice response corresponding to the voice question about the ADAS using LLM.

5. A non-transitory recording medium having recorded thereon a computer program for causing a processor to execute a process comprising:
acquiring a voice question about ADAS accepted from a driver driving a vehicle;
recognizing the voice question about the ADAS; and
generating a voice response corresponding to the voice question about the ADAS using LLM.
